(19) United States
(12) Patent Application Publication
(10) Pub. No.: US 2013/0203928 A1
(43) Pub. Date: Aug. 8, 2013

(54) PROCESS FOR PRODUCING POLYMER-CNT COMPOSITES

(71) Applicants: Heiko Hocke, Leverkusen (DE); John Vitovsky, Seabrook, TX (US)

(72) Inventors: Heiko Hocke, Leverkusen (DE); John Vitovsky, Seabrook, TX (US)

(73) Assignee: BAYER INTELLECTUAL PROPERTY GMBH, Monheim (DE)

(21) Appl. No.: 13/820,472

(22) PCT Filed: Sep. 2, 2011
(86) PCT No.: PCT/EP11/65215

§ 371 Date: Apr. 26, 2013

(30) Foreign Application Priority Data
Sep. 7, 2010 (EP) 10175594.0

(51) Int. Cl. C08K 3/04

(52) U.S. Cl. CPC C08K 3/04
USPC 524/496

(57) ABSTRACT

A process for producing polymer-carbon nanotube (CNT) composites comprises the steps of: (A) providing carbon nanotube agglomerates with an average agglomerate size of ≧0.02 mm to ≦6 mm; (B) contacting the carbon nanotube agglomerates with an impregnation material, the contacting being performed in such a way that ≧50 wt. %, based on the weight of the carbon nanotubes, of the carbon nanotube agglomerates after contacting still has an average agglomerate size of ≧0.02 mm; and (C) incorporating the carbon nanotube agglomerates which have been contacted with an impregnation material and obtained in step (B) into a thermoplastic polymer material or into a reactive resin system. The invention further relates to carbon nanotube agglomerates which have been contacted with an impregnation material and to a polymer composite comprising carbon nanotubes.

The present invention relates to a process for the production of polymer-carbon nanotube composites, comprising the steps of preparing carbon nanotube agglomerates with an average agglomerate size of ≧0.02 mm to ≦6 mm, contacting the carbon nanotube agglomerates with an impregnating material and incorporating the carbon nanotube agglomerates contacted with an impregnating material into a thermoplastic polymer material or a reactive resin system.

The invention also relates to carbon nanotube agglomerates contacted with an impregnating material and to a polymer composite comprising carbon nanotubes.

Carbon nanotubes (CNTs) are known for their extraordinary properties. For example, their strength is approximately 100 times that of steel, their thermal conductivity is about as high as that of diamond, their heat stability reaches to as high as 2800° C. in a vacuum and their electrical conductivity can be many times that of copper. However, these structurally-related characteristics are often only accessible on a molecular level when carbon nanotubes are successfully distributed homogeneously and the greatest possible contact is established between the tubes and the medium, i.e. these are made compatible with the medium and thus able to form a stable dispersion. With regard to electrical conductivity, moreover, it is necessary to form a network of tubes in which ideally they only touch one another or come sufficiently close to one another at the ends. In this case, the carbon nanotubes should as far as possible be present individually, i.e. without agglomerates, non-aligned and in a concentration at which such a network can just form, which is reflected by the sudden increase in electrical conductivity as a function of the concentration of carbon nanotubes (percolation threshold). To achieve improved mechanical properties of composites, as observed e.g. in reactive resins such as epoxides, excellent dispersion and separation of the carbon nanotubes are again necessary since larger agglomerates lead to fracture sites (Zhou, eXPRESS Polym. Lett. 2008, 2, 1, 40-48) and then a deterioration of the mechanical properties of such composites is more likely to be observed.

For technical applications, therefore, the incorporation of such particles into polymer matrices is interesting, but also a challenge. Two aspects have to be taken into consideration for successful processing of carbon nanotubes if a material is to be made, for example, electrically conductive and/or mechanically better through the use thereof: the complete break-up and debundling of carbon nanotube agglomerates and—often—suppression of the great tendency of carbon nanotubes to reaggregate (in one and the same medium during the ageing process or during processing of such a dispersion to form the finished material). These difficulties in carbon nanotube processing may be based inter alia on the hydrophobic nature of the carbon nanotube surface, mechanical entanglement of the fibres in the agglomerate or later by diffusion processes and the high aspect ratio of this virtually one-dimensional structure.

US 2007/213450 A1 describes a process for the production of nanotube composite materials, wherein a nanotube dispersion is firstly produced from a plurality of nanotubes and a liquid, this is contacted with a polymer melt and the two are mixed together to obtain a nanotube composite melt and the liquid is removed by evaporation. In the process described there, the CNT agglomerates are destroyed by the input of energy in the liquid and the CNTs are thereby separated or dispersed. Dispersion preferably takes place here by means of ultrasound. The concentration of nanotubes in the liquid is very low, generally below 1 wt. %.

WO 2008/106572 A1 discloses a polymer composition comprising a resin matrix with a mixture of a resin and carbon nanotubes as well as a polymer matrix. The polymer composition is obtained by mixing together the resin matrix and the polymer matrix in the melt. However, a dispersing step to produce the resin matrix is considered to be necessary here too, i.e. the CNTs are first separated in the resin matrix by means of energy input (extrusion) and this masterbatch is then mixed with the polymer.

WO 2009/001324 A2 concerns the use of nanotubes comprising at least one element from groups IIIa, IVa and Va of the periodic table to improve the mechanical properties of a polymer matrix comprising at least one semicrystalline thermoplastic polymer at high temperatures. One possibility for mixing the nanotubes and the polymer matrix is direct compounding in an extruder. As a further possibility, predispersion (separation of the nanotubes) in a solvent is described. In particular, ultrasound treatment or rotor-stator mills are mentioned here as possible ways of dispersing.

WO 2010/051942 A1 relates to a composition comprising a propylene-olefin copolymer wax and carbon nanotubes. With regard to the incorporation of the nanotubes, it is disclosed only that simultaneous mixing can take place.

The previous dispersing of carbon nanotubes in a dispersing medium before incorporation into polymers, e.g. by ultrasound treatment or mechanical action, is always associated with increased energy costs for the process overall.

The admixing of a CNT-containing liquid into a polymer is associated with considerable difficulties owing to the very different viscosities, particularly in the case of economically preferable mixing processes such as mixing in a kneader, extruder or roll mill. The subsequent evaporation of the liquid is associated with considerable energy costs, especially in the case of very dilute nanotube dispersions, and entails considerable problems, particularly on an industrial scale, owing to the amount of energy required. The reproducible metering of the dispersions into the melt also represents a technical challenge industrially.

With regard to the direct incorporation of CNTs into a polymer melt, there is the additional question of whether the agglomerates of the nanotubes are satisfactorily broken up so as to obtain separate nanotubes dispersed in the polymer.

The present invention is therefore based on the object of improving a process for the production of electrically conductive and/or mechanically enhanced polymer-carbon nanotube composites by reducing the overall energy costs of the process while at the same time achieving a high degree of separation of the nanotubes (dispersion quality).

The object is achieved according to the invention by a process for the production of polymer-carbon nanotube composites, comprising the following steps:
(A) preparing carbon nanotube agglomerates with an average agglomerate size of ≧0.02 mm to ≦6 mm;
(B) contacting the carbon nanotube agglomerates with an impregnating material, the contacting being performed in such a way that ≧50 wt. %, based on the weight of the carbon nanotubes, of the carbon nanotube agglomerates still have an average agglomerate size of ≧0.02 mm after the contacting; and
(C) incorporating the carbon nanotube agglomerates contacted with an impregnating material obtained in step (B) into a thermoplastic polymer material or reactive resin system.

Surprisingly, it has been found that, by means of the process according to the invention, when the previously substantially intact agglomerates are incorporated in step (C) they can be broken up and as a result, the carbon nanotubes can be dispersed in the polymer better than in the case of direct compounding without impregnating material. On the one hand it was found that less energy is needed during the incorporation itself. In addition, a great deal of energy is saved because predispersion, e.g. by ultrasound treatment of a dispersion of the aggregates in a liquid, is avoided.

The process also provides a simple solution to the introduction and mixing of a low-viscosity with a high-viscosity material, since the low-viscosity liquid absorbed into the carbon nanotube agglomerates is released and immediately mixed when the agglomerates are dispersed in the higher-viscosity material.

In addition, implementation and handling, e.g. during metering, are very simple and require no technical expense or conversion on the part of the user, in comparison to the processing of non-impregnated CNTs.

A further advantage of the process according to the invention lies in a reduction in the dustiness of the carbon nanotubes, which results in simplified handling and reduction of possible exposure to CNTs during extrusion.

Carbon nanotubes within the meaning of the invention are all single-wall or multi-wall carbon nanotubes of the cylinder type (e.g. in U.S. Pat. No. 5,747,161; WO 86/03455), scroll type, multi-scroll type, cup-stacked type consisting of conical cups closed at one end or open at both ends (e.g. in EP-A 198,558 and U.S. Pat. No. 7,018,601 B2), or with an onion-type structure. It is preferred to use multi-wall carbon nanotubes of the cylinder type, scroll type, multi-scroll type and cup-stacked type or mixtures thereof. It is favourable if the carbon nanotubes have a ratio of length to external diameter of ≧5, preferably ≧100.

In contrast to the already mentioned, known carbon nanotubes of the scroll type with only one continuous or interrupted graphene layer, carbon nanotube structures also exist which consist of several graphene layers which are stacked and rolled up. These are referred to as the multi-scroll type. These carbon nanotubes are described in DE 10 2007 044031 A1, to which reference is made in full. The relationship of this structure to the carbon nanotubes of the simple scroll type is comparable to that of the structure of multi-wall cylindrical carbon nanotubes (cylindrical MWNTs) to the structure of single-wall cylindrical carbon nanotubes (cylindrical SWNTs).

In contrast to the onion-type structures, the individual graphene or graphite layers in these carbon nanotubes, seen in cross section, apparently run continuously from the centre of the carbon nanotubes to the outer edge without interruption. This can, for example, enable improved and more rapid intercalation of other materials in the tube framework, since more open ends are available as entry zones for the intercalates in comparison to carbon nanotubes with a simple scroll structure (Carbon 1996, 34, 1301-3) or CNTs with an onion-type structure (Science 1994, 263, 1744-7).

According to the invention, it is provided that in step (A) the carbon nanotubes are prepared in the form of agglomerates. The agglomerated form is the form of carbon nanotubes in which they are commercially available. Several types of agglomerate structures can be differentiated (cf. e.g. Moy U.S. Pat. No. 6,294,144B1): the bird's nest structure (BN), the combed yarn structure (CY) and the open net structure (ON). Other agglomerate structures are known, e.g. one in which the carbon nanotubes are arranged in the form of bulk yarns (Hocke, WO PCT/EP2010/004845). Nanotubes aligned parallel on surfaces in the form of carpets or forests, so-called forest structures, are also described (e.g. patent Dai U.S. Pat. No. 6,232,706 and Lemaire U.S. Pat. No. 7,744,793B2). Here, the adjacent tubes are aligned predominantly parallel to one another. The above forms of agglomerate may be used both in any mixture with one another and as a mixed hybrid, i.e. different structures within one agglomerate.

The prepared agglomerates have an average agglomerate size of ≧0.02 mm. This value can be determined by means of laser diffraction spectrometry (an example of an instrument is the Mastersizer MS 2000 with dispersing unit Hydro S from Malvern; in water). The upper limit of agglomerate size can be for example ≦6 mm. The average agglomerate size is preferably ≧0.05 mm to ≦2 mm and more preferably ≧0.1 mm to ≦1 mm Between step (A) and step (B), according to the invention no step takes place in which the agglomerates are comminuted (as is the case e.g. with high speed stirring), so that pourable agglomerates are used in step (B).

In step (B) of the process according to the invention, the agglomerates are contacted with an impregnating material. The impregnating material here is liquid under the conditions prevailing in step (B) and wets at least part of the surface of the carbon nanotubes.

The impregnating agent itself can be a substance specially selected for this purpose or a substance that is conventionally incorporated into polymers. Examples of this latter case are flame retardants, mould release agents, plasticisers, stabilisers or other additives that are conventional in the polymer industry, as the pure substance, as a dispersion or in a solvent. Another possibility is that the impregnating agent represents or contains a component of a reactive system. In this case, in particular polyols, isocyanates, epoxides, amines and phenols should be mentioned, which are reacted to form polyurethane, epoxy and phenolic resins respectively. The impregnating material can, in one embodiment, be present in the form of an aqueous or non-aqueous solution or dispersion.

In a preferred embodiment the impregnating agent does not comprise any substances that are reactive towards carbon nanotubes, such as e.g. coupling agents.

The contacting here is performed such that ≧50 wt. %, preferably ≧75 wt. % and particularly preferably ≧90 wt. %, based in each case on the weight of the carbon nanotubes, of the agglomerates after contacting still have an agglomerate size in the range of ≧0.02 mm. Consequently, efforts are made to ensure that no breakage, or only low breakage, of the aggregates occurs during contacting. Depending on the impregnating agent and amount as well as the implementation, aggregation can also occur which results in the original agglomerates sticking together to form larger agglomerates. This case is included according to the invention. The contacting can take place e.g. in a drum mixer or tumble dryer, but other processes and equipment known to the person skilled in the art can also be used.

During contacting, at least part of the impregnating material remains on the agglomerates before they are used in the following step of the process. This includes the case in which the impregnating agent represents a solution or dispersion of a substance—e.g. of an oligomer or polymer in a solvent for better adjustment of a specific, low viscosity for better diffusion into the agglomerate—and the solvent has been removed again after impregnation by evaporation, distillation or other separating methods. In a preferred embodiment, more than 70 wt. %, preferably more than 80 wt. %, particularly preferably more than 90 wt. % and most particularly preferably all of the impregnating material remains on the agglomerates.

Step (C) of the process according to the invention contains the incorporation of the agglomerates obtained in step (B). As already described, agglomerates that are as intact as possible should be used for this purpose. Incorporation takes place into a thermoplastic polymer material or into a reactive resin system. The term “reactive resin system” here refers to a reaction mixture which reacts to form a polymer. In particular, it can refer to polyurethane-, phenolic resin- and epoxy resin-forming systems.

Embodiments of the process according to the invention are described below, it being possible to combine the embodiments together at will unless the contrary can clearly be inferred from the context.

In one embodiment of the process according to the invention, the carbon nanotubes forming the agglomerates are multi-wall carbon nanotubes with an average external diameter of ≧3 nm to ≦100 nm, preferably ≧5 nm to ≦25 nm and a ratio of length to diameter of ≧5, preferably ≧100.

In another embodiment of the process according to the invention, the impregnating material is selected such that at the temperature prevailing in step (B) it has a viscosity of ≧0.2 mPas to ≦20000 mPas. The viscosity is preferably ≧1 mPas to ≦10000 mPas and particularly preferably ≧10 mPas to ≦2000 mPas. At these viscosities, the impregnating agent can also reach areas lying inside the aggregates better and can infiltrate the agglomerate better and more uniformly overall. The viscosity can be determined for example using a coaxial cylinder rotational viscometer of the Haake Viscotester VT 550 type in accordance with DIN 53019 or DIN EN ISO 3219.

In another embodiment of the process according to the invention, the impregnating material is selected such that its melting point is below the temperature prevailing in step (C). Thus, for example, an impregnating agent which is solid at room temperature can ensure that the agglomerates do not stick together and that, nevertheless, during incorporation the advantages of a liquid impregnating agent can be utilised.

In another embodiment of the process according to the invention, the impregnating material comprises an aqueous solution and/or dispersion of a polymer. This can be, for example, an aqueous solution of polyvinyl pyrrolidone (PVP), of an acrylate, of a latex based on styrene and/or acrylonitrile and similar systems. In this way, even very high molecular-weight polymers, which for example can be processed by extrusion only with difficulty or not at all, can be mixed with carbon nanotubes and a composite can be produced under extrusion conditions. Another advantage of this processing lies in the fact that latex-CNT-based systems with very high CNT concentrations can be produced, as desirable e.g. for masterbatches.

In another embodiment of the process according to the invention, the impregnating material comprises substances which are selected from the group comprising polyethers, esters, ketones, phosphates, phosphonates, sulfonates, sulfonamines, carbonates, carbamates, amines, amides, silicones, organic compounds with long-chain alkyl groups, waxes, glycerides, fats, benzoates, phthalates, adipic acid derivatives, succinic acid derivatives and/or monofunctional epoxides. Preferred organic compounds with long-chain alkyl groups have C₆ alkyl groups, more preferably C₁₂ or higher homologous alkyl groups. Preferred amines are polyether monoamines An example of a preferred ester is resorcinol bis(diphenyl phosphate), which is used as a flame retardant with the designation RDP.

In another embodiment of the process according to the invention, the impregnating material comprises ionic liquids, in particular those built up on the basis of nitrogen (e.g. ammonium, imidazolium ions) or phosphorus (e.g. phosphonium ions).

The impregnating material can be present in a solvent. Examples of solvents are water, acetone, nitriles, alcohols, dimethyl formamide (DMF), N-methylpyrrolidone (NMP), pyrrolidone derivatives, butyl acetate, methoxypropyl acetate, alkyl benzenes and cyclohexane derivatives.

In another embodiment of the process according to the invention, the carbon nanotube agglomerates contacted with the impregnating fluid obtained in step (B) are pourable at room temperature. Pourability refers to the extent of the free movement or the flow behaviour of bulk products. In particular, the agglomerates obtained in step (B) display good pourability. The flow index of these agglomerates is at least ≧10 ml/s, better ≧15 ml/s, preferably ≧20 ml/s and particularly preferably ≧25 ml/s (determined e.g. with the pourability instrument from Karg-Industrietechnik (Code no. 1012.000) model PM and a 15 mm nozzle according to standard ISO 6186). Pourable aggregates display significant advantages during their metering and processing. The degree of pourability can be controlled by means of the nature and amount of the impregnating agent.

In another embodiment of the process according to the invention, in step (B) the weight ratio of carbon nanotube agglomerates to impregnating material is ≧1:4 to ≦10:1. This ratio is preferably ≧1:2 to ≦5:1 and particularly preferably ≧1:1.5 to ≦3:1, in order to guarantee particularly good pourability.

In another embodiment of the process according to the invention, after step (B) the proportion by weight of carbon nanotube agglomerates in the impregnated material is ≧20 wt. %, preferably ≧35 wt. % and particularly preferably ≧40 wt. % of carbon nanotubes. If the support material remains in the polymer after incorporation, it is favourable to retain great flexibility in terms of its proportion in the polymer to establish desired properties in the finished polymer.

In another embodiment of the process according to the invention, in step (C) the carbon nanotube agglomerates contacted with the impregnating material obtained in step (B) are incorporated into the thermoplastic polymer material or the reactive resin system in a proportion of ≧0.01 wt. % to ≦50 wt. % (based on carbon nanotubes). This proportion is preferably ≧0.5 wt. % to ≦30 wt. %. The process according to the invention offers the advantage that even higher contents of carbon nanotubes can be incorporated than was previously possible.

The incorporation in step (C) can take place for example in a kneader, roll mill or extruder. This is preferred for reasons of economy, but it is also possible to use other dispersing equipment known to the person skilled in the art. A twin-screw extruder with a L/D ratio ≧10, preferably ≧20, particularly preferably ≧25 and most preferably ≧35 is preferred. Particularly preferred is a co-rotating twin screw extruder (rotating in the same direction).

In another embodiment of the process according to the invention, steps (B) and (C) follow one another directly. By means of a suitable choice of the machine set-up and the process conditions, the steps can be linked together in such a way that the impregnating step is carried out in situ and the dispersing step follows the mixing step directly. As a result, the process appears virtually simultaneous. This is possible e.g. if the impregnating agent has a lower viscosity and/or is easier to melt than the polymer.

In each embodiment, the wetting of the CNT agglomerate first takes place predominantly by the impregnating material before wetting by the polymer takes place.

In a preferred embodiment, the CNT agglomerates and the impregnating agent are fed into a mixing unit first (main or lateral feed section) and then in a time-shifted step the polymer (or resin precursor) is added (lateral feed section).

In another embodiment of the process according to the invention, the thermoplastic polymer material comprises polyamides (for example PA.6, PA.66, PA 12 or PA11), polycarbonate (PC), homo- and copolymers of polyoxymethylene (POM-H, POM-C), thermoplastic polyurethanes (TPUs), polyolefins (for example PP, PE, HDPE, COC, LCP including modified variants), polyethylene terephthalate (PET), polybutylene terephthalate (PBT), polyacrylates (for example polymethyl methacrylate PMMA), styrene polymers (for example PS, HiPS, ASA, SMA), polyacrylonitrile (PAN), polystyrene-acrylonitrile (SAN), polyacrylonitrile-butadiene-styrene (ABS), polyvinyl chloride (PVC), fluorinated polymers (for example polyvinylidene fluoride PVDF, ethylene tetrafluoroethylene ETFE), perfluoroethylene propylene FEP), polyether imide (PEI), polyether ether ketone (PEEK), polyphenylene sulfide (PPS), polyphenylene sulfone (PSU) or polyphenyl ethers (for example PPO, PPE) or blends, block copolymer forms or modifications of the aforementioned polymers.

In another embodiment of the process according to the invention, the reactive resin system comprises epoxides (in particular those made from bisphenol A and/or bisphenol F), polyurethanes (in particular those built up from aromatic diisocyanates such as toluene-2,4-diisocyanate TDI and/or diphenylmethane diisocyanate MDI or aliphatic diisocyanates such as hexamethylene diisocyanate HDI and/or 3-isocyanatomethyl-3,5,5-trimethylcyclohexyl isocyanate IPDI and/or 4,4′-diisocyanato-dicyclohexylmethane H₁₂-MDI), phenolic resins, unsaturated polyesters and/or aminoplastics.

The present invention further relates to carbon nanotube agglomerates contacted with an impregnating material, wherein ≧50 wt. %, preferably ≧75 wt. % and particularly preferably ≧90 wt. %, based on the weight of the carbon nanotubes, of the carbon nanotube agglomerates have an average agglomerate size of ≧0.02 mm.

The agglomerates here are distinguished by the fact that the impregnating material comprises substances which are selected from the group comprising polyethers, esters, ketones, phosphates, phosphonates, sulfonates, sulfonamines, carbonates, carbamates, amines, amides, silicones, organic compounds with long-chain alkyl groups, waxes, glycerides, fats, benzoates, phthalates, adipic acid derivatives, succinic acid derivatives and/or monofunctional epoxides.

The average agglomerate size according to the invention is ≧0.02 mm. This value can be determined by means of laser diffraction spectrometry (an example of an instrument is the Mastersizer MS 2000 with Hydro S dispersion unit from Malvern; in water). The upper limit of the agglomerate size can be for example ≦6 mm. The average agglomerate size is preferably ≧0.05 mm to ≦2 mm and more preferably ≧0.1 mm to ≦1 mm.

Preferred organic compounds with long-chain alkyl groups have C₆ alkyl groups, and more preferably C₁₂ or higher homologous alkyl groups.

The impregnating material can be present in a solvent. Examples of solvents are water, acetone, nitriles, alcohols, dimethyl formamide (DMF), N-methylpyrrolidone (NMP), pyrrolidone derivatives, butyl acetate, methoxypropyl acetate, alkyl benzenes and cyclohexane derivatives.

To avoid repetition, reference is made to the above statements with regard to details and preferred embodiments.

The present invention also provides a polymer composite comprising carbon nanotubes, obtainable by a process according to the present invention, wherein the proportion of carbon nanotubes is ≦50 wt. % and the proportion of carbon nanotubes present in agglomerates with an average agglomerate size of ≧0.02 mm to ≦6 mm in the total amount of carbon nanotubes is ≦10 wt. %.

The proportion of carbon nanotubes is preferably ≦7 wt. % and particularly preferably ≦3 wt. %. It is furthermore preferred for this proportion to be ≧0.01 wt. % and more preferably ≧0.1 wt. %.

The proportion of carbon nanotubes present in agglomerates with an average agglomerate size of ≧0.02 mm to ≦6 mm in the total amount of carbon nanotubes is preferably ≦5 wt. % and particularly preferably ≦2 wt. %.

As already described in connection with the process according to the invention, the polymer of the polymer composite can be a thermoplastic polymer or a polymer obtained from a reactive resin system. To avoid repetition, reference is made to the above statements with regard to details and preferred embodiments.

In a preferred embodiment, the composition contains no microgels after step (B) and/or after step (C).

The present invention is further explained with the aid of the following examples, but without being restricted thereto.

Production of the Compounds

Baytubes® C 150 P (Bayer MaterialScience AG) were used as CNTs. These are multi-wall CNTs with an average external diameter of 13 nm to 16 nm and a length of over 1 μm. Baytubes® C 150 P are also present as agglomerates with an average particle size of 0.1 mm to 1 mm. The bulk density according to EN ISO 60 is 120 kg/m³ to 170 kg/m³.

Impregnation:

The CNT agglomerates were contacted with the impregnating material given in Table 1-1 in a ratio of 2 parts by weight CNTs and 1 part by weight impregnating material in a drum mixer for at least 12 hours. Where necessary, heating was additionally applied during this operation. In the comparative tests the CNT agglomerates were incorporated dry (without an impregnating step).

The CNT agglomerates were contacted with the impregnating material given in Tables 1-2 and 1-4 in a ratio of 1 part by weight CNTs and 2 parts by weight impregnating material in a heatable tumble dryer for at least one hour. In the comparative tests this step was omitted.

The CNT agglomerates were contacted with the impregnating material given in Table 1-3 in a ratio of 1 part by weight CNTs and 2 parts by weight impregnating material in a drum mixer for at least 12 hours. Where necessary, heating was additionally applied during this operation. In the comparative tests the CNT agglomerates were incorporated dry (without an impregnating step).

Method A: Direct Compound

The CNTs were incorporated into a polymer in a ZSK-26 Megacompounder (Coperion) with a ratio of length to diameter L/D=37. In the tests with “PA6” in the test name, a polyamide 6 (Durethan® B29 from Lanxess) was used, and in the tests with the name

“PA12” a polyamide 12 (Grilamid® TR 55 from EMS-Grivory) was used. The polymer was dried before extrusion. The drying details can be found in Table 5. Polymer and filler were metered into the main feed of the extruder. Details of the extrusion conditions can be found in Tables 2-1 to 2-3. “TM1” refers here to the processing temperature in the extruder. The screw configuration “A” consists of approx. 30% kneading and mixing elements and approx. 70% conveying elements. The screw configuration “B” consists of approx. 15% kneading and mixing elements and approx. 85% conveying elements. The compound came out of the die plate of the extruder as strands. After extrusion, it was cooled in a water bath, dried with a stream of air and finally granulated.

In the tests designated “HDPE”, high density polyethylene (Lupolen® 4261 AG from Lyondell-Basell) was used. The tests were performed in a ZSE 27 MAXX extruder (Leistritz) with a ratio of length to diameter L/D=45. The polymer was not dried before extrusion. Polymer and filler were metered into the main feed of the extruder. Details of the extrusion conditions can be found in Table 2-4. “TM1” refers here to the processing temperature in the extruder. The screw configuration “C” consists of approx. 15% kneading elements and approx. 85% conveying elements. The compound came out of the die plate of the extruder as strands. After extrusion, it was cooled in a water bath, dried with a stream of air and finally granulated.

2-3 kg direct compound per batch were produced.

Method B: Masterbatch and Dilution

For the production of compounded polymers via masterbatch, PA12 (Grilamid® TR 55 from EMS-Grivory) was used.

In a first step, a masterbatch (batch size=3-4 kg) with 15 wt. % CNTs was produced. CNTs were incorporated into the polyamide, which had been dried before extrusion, in a ZSK-26 Megacompounder (Coperion) with a ratio of length to diameter L/D=37. The polymer was dried (the drying details can be found in Table 5) and metered into the main feed of the extruder. Details of the extrusion conditions can be found in Table 2-3. “TM1” refers here to the processing temperature in the extruder. In the extruder, screw configuration “B” was used, which consists of approx. 15% kneading and mixing elements and approx. 85% conveying elements. The compound came out of the die plate of the extruder in strands. After extrusion, it was cooled in a water bath, dried with a stream of air and finally granulated.

The masterbatch was diluted with pure PA12 in a subsequent extrusion step. The dilution again took place in the ZSK-26 Megacompounder. Polymer and masterbatch were dried under the same conditions (cf. Table 5) and metered together into the main feed of the extruder. The extrusion took place in accordance with the above description.

Testing

A portion of the compounded polymer was formed into a pressed sheet (80 mm diameter, 2 mm thick) in a heated press (Polystat 400S from Schwabenthan). The production process for the pressed sheets was documented for each type of polymer in Table 6. After cooling, the pressed sheet was provided in the middle with 2 parallel stripes of a silver paint so that a square was formed with a side length of 2.5 cm which was open on 2 opposite sides. It was dried again and the surface resistance was measured with a resistance meter. A further portion of the compounded polymer was formed by means of injection moulding into a sheet referred to as an injection moulded sheet. The surface resistance was measured in accordance with ASTM D-257 using a ring electrode arranged on the sheet (Monroe model 272A measuring instrument). The results are documented in Tables 3-1 to 3-4.

Likewise in Tables 3-1 to 3-4, the degrees of dispersion of the CNTs in the polymer are listed. To determine this parameter, a thin specimen layer was prepared using a microtome and photographed under a microscope. The image obtained was evaluated electronically with the freely available ImageJ program. The area proportion of agglomerates in the photographs A_{AGG} was determined here. Assuming a depth of 1 unit, the proportion by volume of the agglomerates V_{AGG} was calculated according to V_{AGG}=A_{AGG}·1. The proportion by weight of the undispersed CNTs X_{AGG} was calculated on the basis of the assumed density of the agglomerates ρ_{AGG} and the density of the pure polymer ρ_{POLY}: X_{AGG}=(V_{AGG}·ρ_{AGG})/((V_{AGG}·ρ_{AGG})+(1−V_{AGG})·μ_{POLY}). The proportion by weight of the effectively dispersed CNTs X_{EFF} was calculated for the filling proportion of the CNTs X_{TOT} and the undispersed CNT fraction X_{AGG}: X_{EFF}=X_{TOT}−X_{AGG}. The percentage of the dispersed CNTs corresponds to the quotient X_{EFF}/X_{TOT}.

Mechanical analyses of the compounded polymer materials are documented in Tables 4-1 to 4-3. Tensile modulus, yield stress, elongation, tensile strength, tensile stress at break and elongation at break were determined in accordance with ISO 527. The Izod notched impact strength was determined in accordance with ASTM D256A. All the mechanical tests were performed on at least 10 test pieces and are given as an average value.

TABLE 1-1

| Test no. | Impregnating material |
|---|---|
| PA6X01 | Comparative test with direct incorporation into the polymer |
| PA6X02 | Comparative test with direct incorporation into the polymer |
| PA6X03 | Comparative test with direct incorporation into the polymer |
| PA6X04 | Surfonamine B200 (polyether monoamine, Huntsman) |
| PA6X05 | Surfonamine B200 (polyether monoamine, Huntsman) |
| PA6X06 | Surfonamine B200 (polyether monoamine, Huntsman) |
| PA6X07 | Surfonamine L207 (polyether monoamine, Huntsman) |
| PA6X08 | Surfonamine L207 (polyether monoamine, Huntsman) |
| PA6X09 | Surfonamine L207 (polyether monoamine, Huntsman) |
| PA6X10 | Surfonamine L200 (polyether monoamine, Huntsman) |
| PA6X11 | Surfonamine L200 (polyether monoamine, Huntsman) |
| PA6X12 | Surfonamine L200 (polyether monoamine, Huntsman) |

TABLE 1-2

| Test no. | Impregnating material |
|---|---|
| PA6X13 | Comparative test with direct incorporation into the polymer |
| PA6X14 | Comparative test with direct incorporation into the polymer |
| PA6X15 | Comparative test with direct incorporation into the polymer |
| PA6X16 | Reofos ® RDP (resorcinol bis(diphenyl phosphate)), |
| | Chemtura Corporation |
| PA6X17 | Reofos ® RDP (resorcinol bis(diphenyl phosphate)), |
| | Chemtura Corporation |
| PA6X18 | Reofos ® RDP (resorcinol bis(diphenyl phosphate)), |
| | Chemtura Corporation |

TABLE 1-3

| Test no. | Impregnating material |
|---|---|
| PA12X01 | Comparative test with direct incorporation into the polymer |
| PA12X02 | Comparative test with direct incorporation into the polymer |
| PA12X03 | Comparative test with direct incorporation into the polymer |
| PA12X04 | Comparative test - masterbatch in PA12 |
| PA12X05 | Comparative tests - dilution of masterbatch in PA12 |
| PA12X06 | Comparative tests - dilution of masterbatch in PA12 |
| PA12X07 | Comparative tests - dilution of masterbatch in PA12 |
| PA12X08 | Reofos ® RDP (resorcinol bis(diphenyl phosphate)), |
| | Chemtura Corporation |
| PA12X09 | Reofos ® RDP (resorcinol bis(diphenyl phosphate)), |
| | Chemtura Corporation |
| PA12X10 | Reofos ® RDP (resorcinol bis(diphenyl phosphate)), |
| | Chemtura Corporation |

TABLE 1-4

| Test no. | Impregnating material |
|---|---|
| HDPEX01 | Comparative test with direct incorporation into the polymer |
| HDPEX02 | Comparative test with direct incorporation into the polymer |
| HDPEX03 | Comparative test with direct incorporation into the polymer |
| HDPEX04 | Reofos ® RDP (resorcinol bis(diphenyl phosphate)), |
| | Chemtura Corporation |
| HDPEX05 | Reofos ® RDP (resorcinol bis(diphenyl phosphate)), |
| | Chemtura Corporation |

TABLE 2-1

| | Feed | | Torque | Energy input | TM1 | Screw |
|---|---|---|---|---|---|---|
| Test no. | [kg/h] | rpm | [%] | [kWh/kg] | [° C.] | configuration |
| PA6X01 | 24.7 | 400.0 | 70.5 | 0.253 | 281.0 | A |
| PA6X02 | 25.3 | 400.0 | 72.5 | 0.255 | 283.0 | A |
| PA6X03 | 23.8 | 400.0 | 75.0 | 0.280 | 288.0 | A |
| PA6X04 | 24.7 | 400.0 | 61.5 | 0.221 | 279.0 | A |
| PA6X05 | 25.3 | 400.0 | 61.5 | 0.216 | 279.0 | A |
| PA6X06 | 25.9 | 400.0 | 63.5 | 0.217 | 280.0 | A |
| PA6X07 | 24.7 | 400.0 | 60.0 | 0.215 | 279.0 | A |
| PA6X08 | 25.3 | 400.0 | 63.0 | 0.221 | 280.0 | A |
| PA6X09 | 25.9 | 400.0 | 64.5 | 0.221 | 281.0 | A |
| PA6X10 | 25.1 | 400.0 | 64.5 | 0.228 | 280.0 | A |
| PA6X11 | 25.9 | 400.0 | 65.0 | 0.223 | 281.0 | A |
| PA6X12 | 26.9 | 400.0 | 67.0 | 0.221 | 283.0 | A |

TABLE 2-2

| | Feed | | Torque | Energy input | TM1 | Screw |
|---|---|---|---|---|---|---|
| Test no. | [kg/h] | rpm | [%] | [kWh/kg] | [° C.] | configuration |
| PA6X13 | 25.0 | 400.0 | 72.0 | 0.256 | 282.0 | A |
| PA6X14 | 25.0 | 400.0 | 73.5 | 0.261 | 284.0 | A |
| PA6X15 | 23.8 | 400.0 | 72.5 | 0.271 | 288.0 | A |
| PA6X16 | 25.0 | 400.0 | 49.5 | 0.176 | 280.0 | A |
| PA6X17 | 25.0 | 400.0 | 64.0 | 0.227 | 282.0 | A |
| PA6X18 | 23.8 | 400.0 | 51.0 | 0.190 | 280.0 | A |

TABLE 2-3

| | Feed | | Torque | Energy input | TM1 | Screw |
|---|---|---|---|---|---|---|
| Test no. | [kg/h] | rpm | [%] | [kWh/kg] | [° C.] | configuration |
| PA12X01 | 25.0 | 400 | 73.0 | 0.259 | 287.0 | B |
| PA12X02 | 25.0 | 400 | 71.5 | 0.254 | 288.0 | B |
| PA12X03 | 25.0 | 400 | 73.5 | 0.261 | 290.0 | B |
| PA12X04 | 15.0 | 400 | 69.5 | 0.411 | 313.0 | B |
| PA12X05 | 25.0 | 400 | 73.0 | 0.259 | 283.0 | B |
| PA12X06 | 25.0 | 400 | 74.0 | 0.263 | 285.0 | B |
| PA12X07 | 25.0 | 400 | 74.5 | 0.265 | 288.0 | B |
| PA12X08 | 25.0 | 400 | 67.0 | 0.238 | 282.0 | B |
| PA12X09 | 25.0 | 400 | 63.0 | 0.224 | 282.0 | B |
| PA12X10 | 25.0 | 400 | 49.0 | 0.174 | 282.0 | B |

TABLE 2-4

| | Feed | | Torque | Energy input | TM1 | Screw |
|---|---|---|---|---|---|---|
| Test no. | [kg/h] | rpm | [%] | [kWh/kg] | [° C.] | configuration |
| HDPEX01 | 20.0 | 325.0 | 72.0 | 0.314 | 265.1 | C |
| HDPEX02 | 20.0 | 325.0 | 73.0 | 0.318 | 267.1 | C |
| HDPEX03 | 20.0 | 325.0 | 71.0 | 0.309 | 266.0 | C |
| HDPEX04 | 20.0 | 325 | 56.0 | 0.244 | 266.1 | C |
| HDPEX05 | 20.0 | 325 | 53.0 | 0.231 | 266.1 | C |

TABLE 3-1

| | | Pressed | Injection | |
|---|---|---|---|---|
| | CNT | sheet | moulded sheet | |
| | content | resistance | resistance | Degree of |
| Test no. | [wt. %] | [Ohm-sq] | [Ohm-sq] | dispersion |
| PA6X01 | 3.0 | 4.00E+04 | 1.69E+12 | 58% |
| PA6X02 | 5.0 | 1.20E+02 | 5.86E+07 | 59% |
| PA6X03 | 7.5 | 2.70E+01 | 2.81E+05 | 55% |
| PA6X04 | 2.0 | 6.65E+03 | 3.59E+12 | 89% |
| PA6X05 | 3.0 | 2.31E+02 | 2.47E+10 | 87% |
| PA6X06 | 5.0 | 4.50E+01 | 6.54E+06 | 86% |
| PA6X07 | 2.0 | 2.32E+04 | 5.74E+12 | 86% |
| PA6X08 | 3.0 | 7.20E+03 | 1.98E+10 | 85% |
| PA6X09 | 5.0 | 8.31E+01 | 7.94E+06 | 89% |
| PA6X10 | 3.0 | 4.84E+02 | 3.04E+12 | 87% |
| PA6X11 | 5.0 | 9.94E+01 | 2.41E+06 | 83% |
| PA6X12 | 7.5 | 1.58E+02 | 1.19E+06 | 87% |

TABLE 3-2

| | | Pressed | Injection | |
|---|---|---|---|---|
| | CNT | sheet | moulded sheet | |
| | content | resistance | resistance | Degree of |
| Test no. | [wt. %] | [Ohm-sq] | [Ohm-sq] | dispersion |
| PA6X13 | 3.0 | 2.16E+04 | 2.21E+11 | 74% |
| PA6X14 | 5.0 | 1.09E+03 | 3.98E+09 | 82% |
| PA6X15 | 7.5 | 9.21E+01 | 1.05E+07 | 88% |
| PA6X16 | 3.0 | 7.80E+01 | 8.24E+10 | 99%+ |
| PA6X17 | 5.0 | 2.67E+01 | 5.24E+07 | 99%+ |
| PA6X18 | 7.5 | 9.10E+00 | | 99%+ |

TABLE 3-3

| | | Pressed | Injection | |
|---|---|---|---|---|
| | CNT | sheet | moulded sheet | |
| | content | resistance | resistance | Degree of |
| Test no. | [wt. %] | [Ohm-sq] | [Ohm-sq] | dispersion |
| PA12X01 | 2.0 | — | 2.17E+12 | 73% |
| PA12X02 | 3.0 | 3.37E+02 | 2.77E+11 | 64% |
| PA12X03 | 5.0 | 3.05E+01 | 1.16E+07 | 67% |
| PA12X04 | 15 | — | — | — |
| PA12X05 | 2.0 | 3.07E+03 | 1.73E+12 | 90% |
| PA12X06 | 3.0 | 8.88E+03 | 2.88E+11 | 88% |
| PA12X07 | 5.0 | — | 1.31E+07 | 94% |
| PA12X08 | 2.0 | 8.66E+02 | 1.03E+12 | 90% |
| PA12X09 | 3.0 | 6.31E+01 | 8.29E+09 | 91% |
| PA12X10 | 5.0 | 3.41E+01 | 2.36E+05 | 96% |

TABLE 3-4

| | | Pressed | Injection | |
|---|---|---|---|---|
| | CNT | sheet | moulded sheet | |
| | content | resistance | resistance | Degree of |
| Test no. | [wt. %] | [Ohm-sq] | [Ohm-sq] | dispersion |
| HDPEX01 | 3.0 | 1.02E+10 | — | 88% |
| HDPEX02 | 5.0 | 3.04E+06 | — | 86% |
| HDPEX03 | 7.5 | 5.97E+02 | — | 82% |
| HDPEX04 | 3.0 | 6.87E+09 | — | 99% |
| HDPEX05 | 5.0 | 3.42E+04 | — | 99% |

TABLE 4-1

| | | | | | | | Izod |
|---|---|---|---|---|---|---|---|
| | Tensile | Yield | | Tensile | Tensile | Elongation | notched |
| | modulus | stress | | strength | stress at | at | impact |
| | RT | [MPa], | Elongation | [MPa], | break | break | strength |
| Test no. | [MPa] 1 mm/min | 50 mm/min | [%], 50 mm/min | 50 mm/min | [MPa], 50 mm/min | [%], 50 mm/min | [J/m], 23° C. |
| PA6X01 | 3427 | 0 | 0 | 89.8 | 89.7 | 3.5 | 65 |
| PA6X02 | 3590 | 0 | 0 | 90.9 | 90.5 | 3.1 | 66 |
| PA6X03 | 3777 | 0 | 0 | 82.4 | 82.4 | 2.5 | 51 |
| PA6X04 | 3313 | 89.7 | 4 | 89.7 | 58.3 | 32 | 69 |
| PA6X05 | 3466 | 90.3 | 3.8 | 90.3 | 58.8 | 38.5 | 66 |
| PA6X06 | 3578 | 90.2 | 3.8 | 90.2 | 65.3 | 40 | 62 |
| PA6X07 | 3434 | 88.7 | 3.7 | 88.7 | 61.6 | 46.4 | 63 |
| PA6X08 | 3322 | 88 | 3.8 | 88 | 57.7 | 37 | 62 |
| PA6X09 | 3586 | 87.9 | 3.5 | 87.9 | 64.8 | 48.2 | 67 |
| PA6X10 | 3380 | 86.3 | 3.7 | 86.3 | 60.4 | 44.4 | 74 |
| PA6X11 | 3491 | 83.7 | 3.5 | 83.7 | 65.2 | 49.6 | 57 |
| PA6X12 | 3575 | 84.3 | 3.4 | 84.3 | 72.1 | 40.5 | 59 |

TABLE 4-2

| | | | | | | | Izod |
|---|---|---|---|---|---|---|---|
| | Tensile | Yield | | Tensile | Tensile | Elongation | notched |
| | modulus | stress | | strength | stress at | at | impact |
| | RT | [MPa], | Elongation | [MPa], | break | break | strength |
| Test no. | [MPa] 1 mm/min | 50 mm/min | [%], 50 mm/min | 50 mm/min | [MPa], 50 mm/min | [%], 50 mm/min | [J/m], 23° C. |
| PA6X13 | 3427 | 0 | 0 | 89.8 | 89.7 | 3.5 | 65 |
| PA6X14 | 3590 | 0 | 0 | 90.9 | 90.5 | 3.1 | 66 |
| PA6X15 | 3777 | 0 | 0 | 82.4 | 82.4 | 2.5 | 51 |
| PA6X16 | 3252 | 83.9 | 3.7 | 83.9 | 60.2 | 38.2 | 63 |
| PA6X17 | 3208 | 79.7 | 3.7 | 79.4 | 60.3 | 50.2 | 96 |
| PA6X18 | — | — | — | — | — | — | — |

TABLE 4-3

| | | | | | | | Izod |
|---|---|---|---|---|---|---|---|
| | Tensile | Yield | | Tensile | Tensile | Elongation | notched |
| | modulus | stress | | strength | stress at | at | impact |
| | RT | [MPa], | Elongation | [MPa], | break | break | strength |
| Test no. | [MPa] 1 mm/min | 50 mm/min | [%], 50 mm/min | 50 mm/min | [MPa], 50 mm/min | [%], 50 mm/min | [J/m], 23° C. |
| PA12X01 | 2197 | 0 | 0 | 67.4 | 67.4 | 3.9 | 76 |
| PA12X02 | 2252 | 0 | 0 | 60.5 | 60.5 | 4 | 59 |
| PA12X03 | 2374 | 0 | 0 | 65.1 | 65.1 | 3.4 | 60 |
| PA12X04 | — | — | — | — | — | — | — |
| PA12X05 | 2171 | 0 | 0 | 67.6 | 67.4 | 3.9 | 47 |
| PA12X06 | 2203 | 0 | 0 | 65.2 | 65.2 | 3.6 | 55 |
| PA12X07 | 2350 | 0 | 0 | 66.6 | 66.4 | 3.5 | 48 |
| PA12X08 | 2222 | 0 | 0 | 69.2 | 69.2 | 3.9 | 79 |
| PA12X09 | 2326 | 0 | 0 | 67.8 | 67.8 | 3.6 | 85 |
| PA12X10 | 2575 | 0 | 0 | 65.2 | 65.1 | 3 | 60 |

TABLE 5

| | Drying temperature | Minimum drying time |
|---|---|---|
| Polymer | [° C.] | [hours] |
| PA6 | 75 | 5 |
| PA12 | 80 | 4 |
| HDPE | — | — |

TABLE 6

| | Pressing | | | Pressing |
|---|---|---|---|---|
| | temperature | Melting time | Pressing time | pressure |
| Polymer | [° C.] | [minutes] | [minutes] | [bar] |
| PA6 | 280 | 5 | 2 | 50-60 |
| PA12 | 280 | 5 | 2 | 50-60 |
| HDPE | 250 | 5 | 2 | 50-60 |

TABLE 7

| | Melt | Mould | |
|---|---|---|---|
| | temperature | temperature | Injection speed |
| Polymer | [° C.] | [° C.] | [mm/s] |
| PA6 | 310 (290) | 120 | 10 |
| PA12 | 310 | 90 | 10 |
| HDPE | — | — | — |

Results:

The electrically conductive compounds according to the invention, produced by impregnation of CNT agglomerates and subsequent direct compounding, are superior to the compounds from the comparative tests, produced either by direct compounding or via masterbatch and dilution but without impregnation of the CNTs. The degree of dispersion of the compounds according to the invention is improved in comparison with the comparative tests. Moreover, an improvement in some of the mechanical characteristic values and/or the electrical conductivity values was found. In all cases, fewer defects were observed on the surface of the injection mouldings with the compounds according to the invention than with the compounds of the comparative tests.

1. A process for producing a polymer-carbon nanotube composite, comprising:
(A) preparing carbon nanotube agglomerates with an average agglomerate size of ≧0.02 mm to ≦6 mm;
(B) contacting the carbon nanotube agglomerates with an impregnating material, wherein said contacting is performed in such a way that ≧50 wt. %, based on the weight of the carbon nanotubes, of the carbon nanotube agglomerates comprise an average agglomerate size of ≧0.02 mm after the contacting; and
(C) incorporating the carbon nanotube agglomerates contacted with an impregnating material obtained in (B) into a thermoplastic polymer material and/or into a reactive resin system.

2. The process according to claim 1, wherein the carbon nanotubes forming the agglomerates are multi-wall carbon nanotubes with an average external diameter of ≧3 nm to ≦100 nm and a ratio of length to diameter of ≧5.

3. The process according to claim 1, wherein the impregnating material is selected such that, at a temperature prevailing in step (B), said impregnating material has a viscosity of ≧0.2 mPas to ≦20000 mPas.

4. The process according to claim 1, wherein said impregnating material is selected such that a melting point thereof is below a temperature prevailing in (C).

5. The process according to claim 1, wherein the impregnating material comprises an aqueous solution and/or dispersion of a polymer.

6. The process according to claim 1, wherein said impregnating material comprises at least one substance which is selected from the group consisting of polyethers, esters, ketones, phosphates, phosphonates, sulfonates, sulfonamines, carbonates, carbamates, amines, amides, silicones, organic compounds with long-chain alkyl groups, waxes, glycerides, fats, benzoates, phthalates, adipic acid derivatives, succinic acid derivatives and/or monofunctional epoxides.

7. The process according to claim 1, wherein said carbon nanotube agglomerates contacted with the impregnating fluid obtained in (B) are pourable at room temperature.

8. The process according to claim 1, wherein, in (B), the weight ratio of carbon nanotube agglomerates to impregnating material is ≧1:4 to ≦10:1.

9. The process according to claim 1, wherein after (B), the proportion by weight of carbon nanotube agglomerates in said impregnated material is ≧20 wt. % of carbon nanotubes.

10. The process according to claim 1, wherein in (C), said carbon nanotube agglomerates contacted with said impregnating material obtained in (B) are incorporated into the thermoplastic polymer material and/or reactive resin system in a proportion of ≧0.01 wt. % to ≦50 wt. % (based on carbon nanotubes).

11. The process according to claim 1, wherein (B) and (C) follow one another directly.

12. The process according to claim 1, wherein said thermoplastic polymer material comprises one or more of polyamides, polycarbonate, homo- and copolymers of polyoxymethylene, thermoplastic polyurethanes, polyolefins, polyethylene terephthalate, polybutylene terephthalate, polyacrylates, styrene polymers, polyacrylonitrile, polystyrene-acrylonitrile, polyacrylonitrile-butadiene-styrene, polyvinyl chloride, fluorinated polymers, polyether imide, polyether ether ketone, polyphenylene sulfide, polyphenylene sulfone or polyphenyl ethers or blends, block copolymer forms and/or one or more modifications of the aforesaid polymers.

13. The process according to claim 1, wherein the reactive resin system comprises one or more of epoxides, polyurethanes, phenolic resins, unsaturated polyesters and/or aminoplastics.

14. Carbon nanotube agglomerate contacted with an impregnating material, wherein ≧50 wt. %, based on the weight of carbon nanotubes, of the carbon nanotube agglomerate have an average agglomerate size of ≧0.02 mm, wherein said impregnating material comprises one or more substances which are selected from the group consisting of polyethers, esters, ketones, phosphates, phosphonates, sulfonates, sulfonamines, carbonates, carbamates, amines, amides, silicones, organic compounds with long-chain alkyl groups, waxes, glycerides, fats, benzoates, phthalates, adipic acid derivatives, succinic acid derivatives and monofunctional epoxides.

15. A polymer composite comprising carbon nanotubes, obtainable by a process according to claim 1, wherein the proportion of carbon nanotubes is ≦50 wt. % and the proportion of carbon nanotubes present in agglomerates with an average agglomerate size of ≧0.02 mm to ≦6 mm in the total quantity of carbon nanotubes is ≦10 wt. %.
